(19) United States
(12) Patent Application Publication
(10) Pub. No.: US 2017/0308327 A1
(43) Pub. Date: Oct. 26, 2017

(54) Extension Write Buffering

(71) Applicant: Hewlett Packard Enterprise Development LP, Houston, TX (US)

(72) Inventors: Gregg B. Lesartre, Fort Collins, CO (US); Martin Foltin, Fort Collins, CO (US)

(21) Appl. No.: 15/136,840

(22) Filed: Apr. 22, 2016

(51) Int. Cl. G06F 3/06

(52) U.S. Cl. CPC G06F 3/0659; G06F 3/0673; G06F 3/0604; G06F 3/0626

(57) ABSTRACT

In various examples, a memory may comprise a subarray having an associated write extension buffer; and request logic to; receive a write request associated with the subarray, execute the write request. The request logic may further determine that the write request has not completed within an allocated number of write cycles, and responsive to determining that the write request has not completed the allocated number of write cycles: store the write request in the write extension buffer.

### BACKGROUND

Computing devices may be coupled to a memory. The memory may execute read and write operations.

### BRIEF DESCRIPTION OF THE DRAWINGS

Certain examples are described in the following detailed description and in reference to the drawings, in which:

FIG. 1 is a conceptual diagram of an example computing system that may perform extension write buffering;

FIG. 2 is another conceptual diagram of an example computing system that may perform extension write buffering;

FIG. 3 is another conceptual diagram of an example computing system that may perform extension write buffering;

FIG. 4 is another conceptual diagram of an example computing system that may perform extension write buffering;

FIG. 5 is a flowchart of an example method for performing extension write buffering; and

FIG. 6 is a flowchart of an example method for performing extension write buffering.

### DETAILED DESCRIPTION

A computing device may comprise a processor, such as a central processing unit (CPU). The CPU may be coupled with a memory controller. The memory controller generates reads and writes to memory coupled with the memory controller. As an example, the memory controller may be coupled to at least one memory. In some examples, the memory may comprise multiple subarrays or banks. Each subarray may comprise a unit of the memory that can be independently accessed (i.e. written or read).

In some examples, the number of cycles to write data to the memory (i.e. the write latency) may vary such that the write is not complete within a write latency allocated by the media controller. However, the memory controller may limit the maximum allowable write latency to achieve the memory performance parameters. The techniques of this disclosure are directed to dealing with writes that do not complete within an allocated number of write cycles.

A memory die as described herein may comprise extension write buffers. Each extension write buffer is associated with a subarray of the memory die. If the memory determines that a write associated with a particular subarray has not completed in the allocated number of cycles, the memory stores the write in the extension buffer associated with the subarray.

Periodically, the memory controller may issue an extension flush operation. The extension flush operation causes the memory die to retry each of the writes stored in the extension write buffers, i.e. the stored writes that have not completed within an allocated number of write cycles to execute. In some examples, the memory controller may issue the extension flush operation after a particular number of cycles. The number of cycles to issue the flush operation may be fixed or variable. In some examples, the extension flush operation may occur based on an observed error rate of the memory. During the extension write operation, the memory controller may alter the parameters used to write data to the memory. For example, the extension write operation may use a longer write sequence than for a non-extension write.

By storing writes in write extension buffers, the memory die can re-attempt to execute writes that require more cycles to complete successfully than the previously-allocated number of write cycles. Additionally, the extension write buffers may simplify the design of the memory controller by allowing the memory dies to appear as though they have a fixed upper bound on write latency when in actuality, the write latency may be significantly higher and more variable.

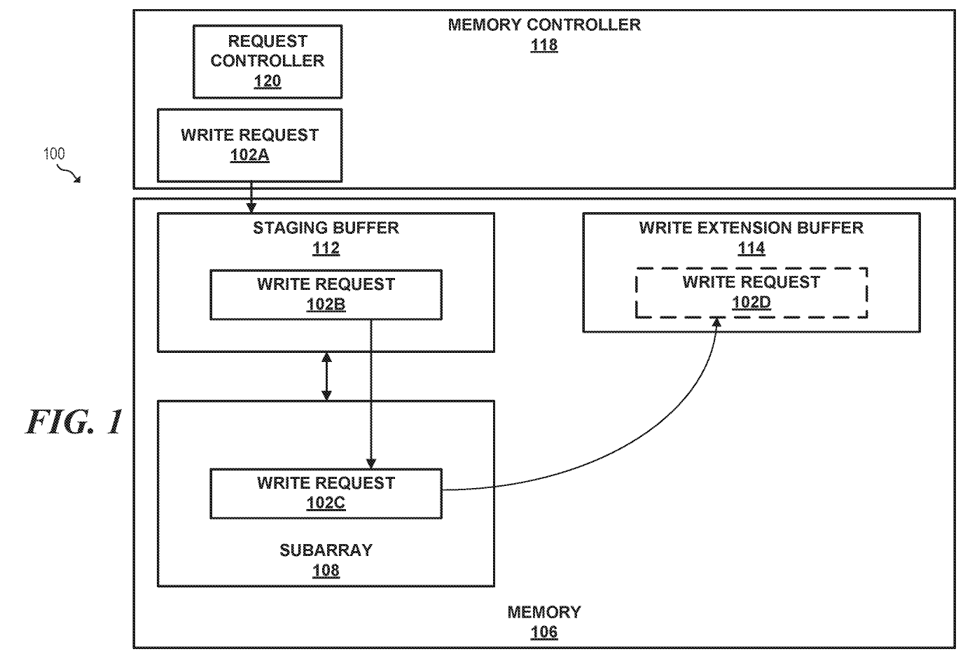

FIG. 1 is a conceptual diagram of an example computing system that may perform extension write buffering. Computing system 100 is illustrated in FIG. 1. Computing system 100 comprises a memory 106, a memory controller 118, and a write request 102A-102D.

In various examples, memory 106 may comprise one or more of dynamic memory, such as double data rate (DDR) random access memory (RAM), static RAM, graphics DDR RAM, (GDDR), high bandwidth memory (HBM), or Hybrid Memory Cube or the like. In some examples, memory 106 may comprise non-volatile memory such as: NAND flash memory, resistive ram (ReRam), phase change RAM (PCRAM), spin transfer torque memory (STTRAM), magneto resistive RAM, or the like. In various examples, memory 106 may comprise a die. The die may be mounted on a dynamic inline memory module, printed circuit board (PCB), a PCIe (Peripheral Component Interconnect Express) card, a drive enclosure, or the like. Memory 106 comprises a subarray 108. Although only a single subarray is illustrated in FIG. 1, any number of subarrays may be present in memory 106.

Each subarray, i.e. subarray 108, may comprise multiple different addressable memory locations and is an independently accessible unit within memory 106. Memory 106 may access different addresses of each subarray in parallel. For example, memory 106 may execute, in parallel, a read operation at a first address of subarray 108, and write data to a second, different address of a different subarray (not pictured) of memory 106.

System 100 also comprises memory controller 118. In some examples, memory controller 118 may comprise a memory controller that is external to memory 106. In various examples, memory controller 118 may be coupled to at least one central processing unit (CPU). In some examples, memory controller 118 may comprise a memory controller that is on a same printed circuit with memory 106. In yet some other examples, memory controller 118 may be distributed and may comprise a plurality of discrete and/or integrated devices. In some examples, memory controller 118 may comprise a CPU memory controller.

Memory controller 118 comprises request controller 120. Request controller 120 may comprise one or more of: a field programmable gate array (FPGA), fixed function logic, an application-specific integrated circuit (ASIC), a digital signal processor (DSP), or a CPU. Request controller 120 receives read and write requests, e.g. from a CPU or a memory controller. Memory controller 118 and the memory controller may be coupled via memory interface, a PCIe interface, a fabric, or the like. In the example of FIG. 1, request controller 120 may generate write request 102A to memory 106 in response to receiving a write request.

Based on each received read or write request, request controller 120 generates a corresponding read or write request that is associated with a particular subarray of memory 106. In some examples, request controller 120 may determine the subarray associated with each generated read or write request based on a physical address of each read or write request.

Responsive to generating a write request, request controller 120 stores the write request in a staging buffer of memory 106, e.g. staging buffer 112. Memory 106 stores writes in staging buffers until Memory 106 receives a write signal from memory controller 118.

In the example of FIG. 1, request controller 120 generates write request 102A, which is associated with subarray 108. Request controller 120 then stores write request 102A in first staging buffer 112. For ease of illustration, write request 102A is referred to as write request 102B and once it is stored in first staging buffer 112.

For the purposes of illustration, write request 102A is illustrated as being associated with subarray 108. It should be noted that any number of subarrays may be present within memory 106, and that write request 102A may be assigned to any of those subarrays.

Responsive to a condition, such as a received write request or a number of cycles, request controller 120 issues a write operation to memory 106. The write operation causes memory 106 to execute write request 102B. For ease of understanding write request 102B is referred to as write request 102C during execution of the write operation, and write request 102C is illustrated as being inside subarray 108, the subarray with which write request 102 is associated.

In various examples, memory controller 118 or memory 106 may allocate a number of write cycles to execute a write operation, e.g. write request 1020. In some examples, the write operation may not complete within the allocated number of write cycles. The operation may not complete within the allocated time due to variability in the physical characteristics of the memory, the value of the data to be written, and/or wear on the memory, as some examples.

Responsive to determining that the write request has not completed within the allocated number of write cycles, to execute, memory controller 118 may cause memory 106 to store the write request, i.e. write request 1020, in a write extension buffer, e.g. write extension buffer 114. Write extension buffer 114 is associated with subarray 108. In various examples, there may be a write extension buffer for each subarray. Each write extension buffer stores write requests that have failed so that that memory 106 may re-attempt execution of the stored write request and so that memory 106 may continue to execute additional read and write requests.

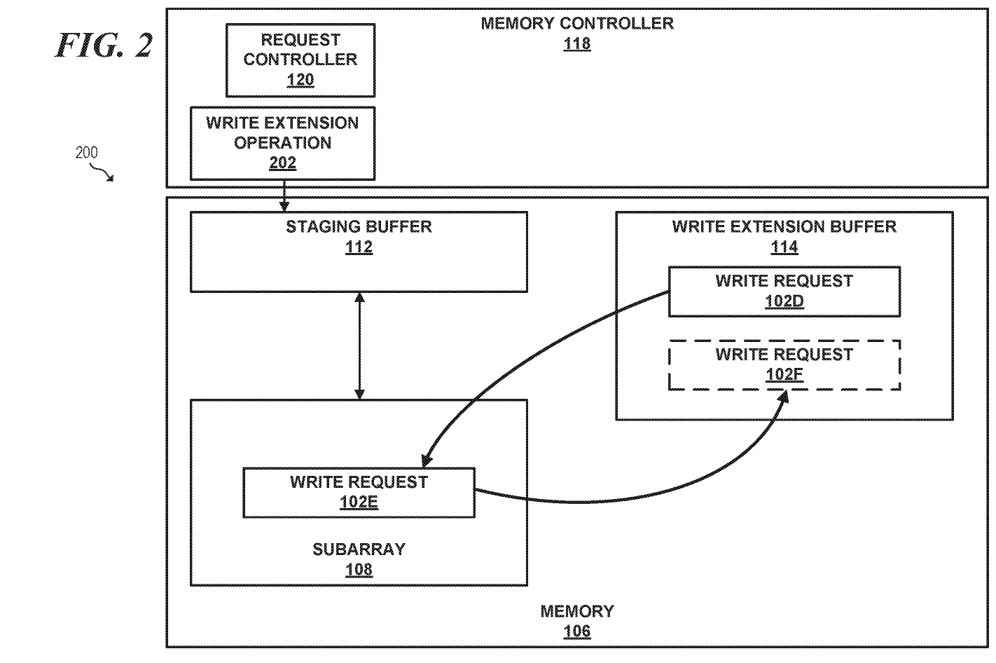

FIG. 2 is another conceptual diagram of an example computing system that may perform extension write buffering. FIG. 2 illustrates a computing system 200. In various examples, computing system 200 may be similar to computing system 100 (FIG. 1).

In the example of FIG. 2, write extension buffer 114 stores write request 102D, which may have previously attempted to executed, and did not complete within an allocated number of write cycles to execute. Memory controller 118 issues a write extension operation 202. The write extension operation may cause memory 106 to execute write requests stored in write extension buffers, e.g. write request 102D, which is stored in write extension buffer 114.

Memory 106 receives write extension operation 202 from memory controller 118. Responsive to receiving write extension operation 202, request controller 120 causes memory 106 to execute request 102D, which is referred to as write request 102E during execution, and is illustrated inside subarray 108. In some examples, request controller 120 may cause memory 106 to execute the write request stored in the write extension buffer, using modified write parameters. Modified write parameters may comprise one or more of: a different write pulse strength, a longer write pulse duration, or the like.

In some examples, issuing the write extension operation may be based on at least one of: a number of write cycles that have elapsed since executing a previous write extension operation, a number of write cycles that have elapsed, or a number of writes that have elapsed. In various examples, request controller 120 may issue the write extension operation, e.g. write extension operation 202, based on an observed error rate of memory 106.

In yet some other examples executing a write request stored in the write extension buffer, e.g. write request 102E, may not complete within a second allocated number of write cycles. In various examples, the second allocated number of write cycles may the same as, or different from the number of cycles originally allocated to execute write request 1020. In these examples, memory controller 118 may cause memory 106 to maintain or return the write request that did not complete in the allocated number of cycles, e.g. write request 102E, to write extension buffer 114. The write request is referred to as write request 102F when it is returned to write extension buffer 114.

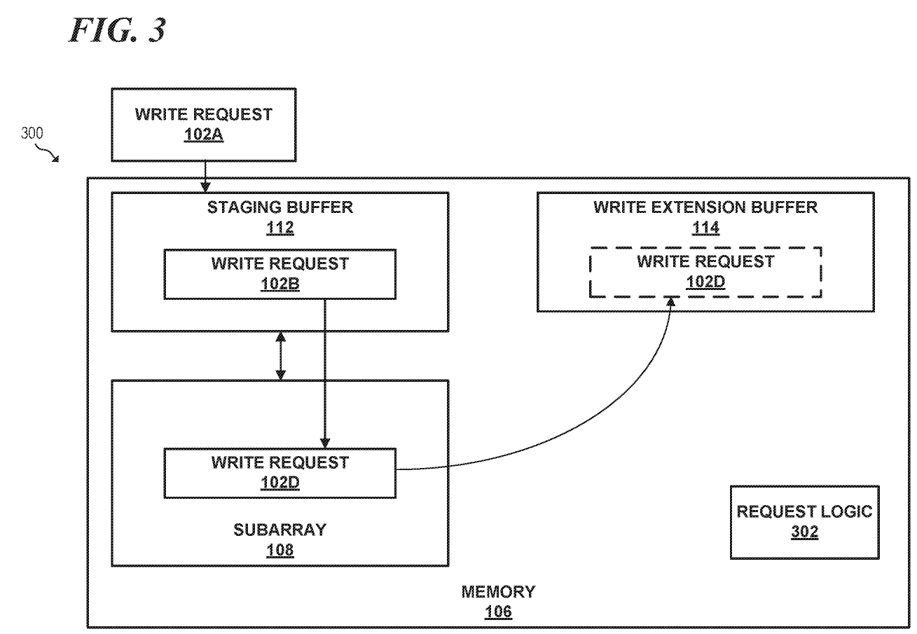

FIG. 3 is another conceptual diagram of an example computing device that may perform extension write buffering. FIG. 3 illustrates a computing system 300. Computing system 300 comprises a memory 106, which is similar to memory 106 of FIGS. 1 and 2. Memory 106 receives write request 102A.

Request logic 302 of memory 106 may process and/or execute read or write requests issued to memory 106. Another device, such as a memory controller (e.g. memory controller 118 of FIG. 1), a memory controller, or the like may issue the read and write requests to memory 106. Request logic 302 may comprise at least one of fixed logic or programmable logic in various examples.

Responsive to receiving write request 102A, request logic 302 causes memory 106 to store write request 102A in staging buffer 112. Write request 102A is referred to as write request 102B once stored in first staging buffer 112. Memory 106 stores writes in staging buffers until Memory 106 receives a write signal from memory controller 118.

For the purposes of illustration, write request 102A is illustrated as being associated with subarray 108. It should be noted that any number of subarrays may be present within memory 106, and that write request 102A may be assigned to any of those subarrays.

Responsive to a condition, such as a received write request or a number of cycles, request logic 302 may execute a write operation. The write operation causes memory 106 to execute write request 102B, i.e. to attempt to execute write request 102B on an associated address of subarray 108. For ease of understanding write request 102B is referred to as write request 1020 during execution of the write operation, and write request 1020 is illustrated as being inside subarray 108, the subarray with which write request 102 is associated.

In various examples, memory controller 118 or memory 106 may allocate a number of write cycles to execute a write operation, e.g. write request 1020. In some examples, the write operation may not complete within the allocated number of write cycles. The operation may not complete within the allocated time due to variability in the physical characteristics of the memory, the value of the data to be written, or wear on the memory, as some examples.

Memory 106 may determine that write request 102D has not completed within the allocated number of write cycles to execute. Responsive to this determination, memory 106 may store the write request, i.e. write request 1020, in a write extension buffer, e.g. write extension buffer 114. In some examples, write extension buffer 114 may comprise a same buffer as staging buffer 112. Memory 106 and/or memory controller 118 may indicate that a region of the buffer is allocated as an extension buffer or a staging buffer based on a value (e.g. a flag) stored in the buffer, as an example.

Write extension buffer 114 is associated with subarray 108. In various examples, there may be a write extension buffer for each subarray. Each write extension buffer stores write requests that have failed so that that memory 106 may re-attempt execution of the stored write request and so that memory 106 may continue to execute additional read and write requests.

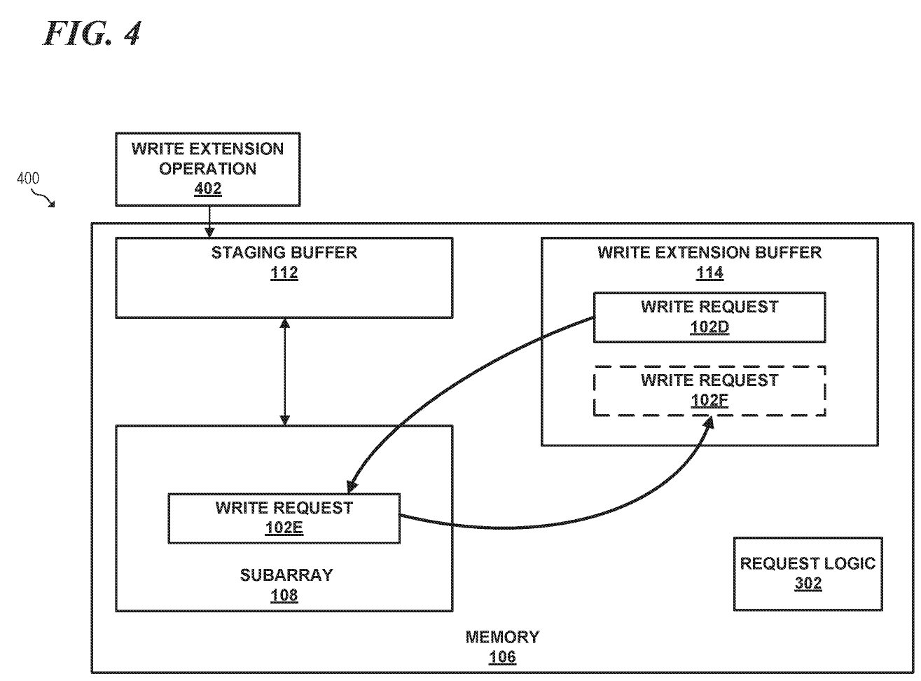

FIG. 4 is another conceptual diagram of an example computing system that may perform extension write buffering. FIG. 4 illustrates a computing system 400. Computing system 400 comprises memory 106, which may be similar to memory 106 of FIGS. 1, 2, and 3 in various examples.

In various examples illustrated in FIG. 4, write extension buffer 114 stores write request 102D, which may have previously attempted to executed, and did not complete within an allocated number of write cycles to execute. Memory controller 118 issues a write extension operation 402 to memory 106. Memory 106 receives write extension operation 402. Write extension operation 402 may cause memory 106 to execute write requests stored in write extension buffers, e.g. write request 102D, which is stored in write extension buffer 114.

Memory 106 receives write extension operation 402 from memory controller 118. Responsive to receiving write extension operation 402, request logic 302 causes memory 106 to execute request 102D, which is referred to as write request 102E during execution, and is illustrated inside subarray 108. In some examples, request controller 120 may cause memory 106 to execute the write request stored in the write extension buffer, using modified write parameters. Modified write parameters may comprise one or more of: a different write pulse strength, a longer write pulse duration, or the like.

In some examples, issuing the write extension operation may be based on at least one of: a number of write cycles that have elapsed since executing a previous write extension operation, a number of write cycles that have elapsed, or a number of writes that have elapsed. In various examples, request logic 302 may execute the write extension operation, e.g. write extension operation 202, based on an observed error rate of memory 106.

In yet some other examples, request logic 302 may determine that write request 102E did not complete within a second allocated number of write cycles. In various examples, the second allocated number of write cycles may the same as, or different from the number of cycles originally allocated to execute write request 102C. In these examples, request logic 302 may cause memory 106 to maintain or return the write request that did not complete in the allocated number of cycles, e.g. write request 102E, to write extension buffer 114. The write request is referred to as write request 102F when it is returned to write extension buffer 114.

It should be understood that FIGS. 1-4 illustrate only a single write request associated with a single subarray for the purposes of example. However, there may be multiple subarrays within a memory, such as memory 106. Each subarray may have an associated extension buffer. Additionally, it should be understood that memory 106 continues to receive write requests while write requests are stored in the extension buffer. Memory 106 may execute the received write requests until receiving a write extension operation, e.g. write extension operation 402. Responsive to receiving the write requests, memory 106 may execute, in parallel, each of the write requests stored in the extension buffers. In various examples, memory 106 may execute a plurality of writes, in parallel, stored in extension buffers across a plurality of memory dies.

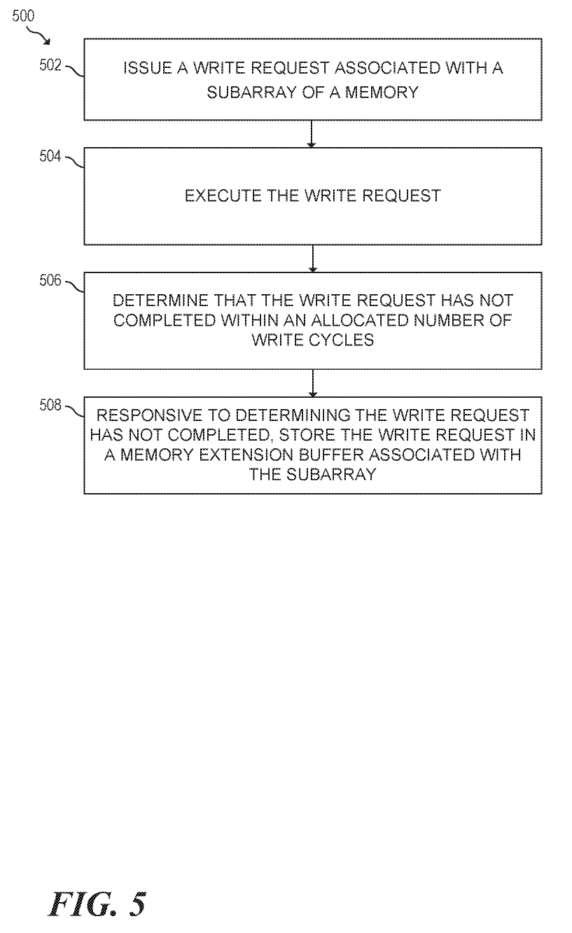

FIG. 5 is a flowchart of an example method for performing extension write buffering. FIG. 5 illustrates method 500. Method 500 may be described below as being executed or performed by a system, for example, computing system 100 (FIG. 1), computing system 200 (FIG. 2), computing system 300 (FIG. 3), computing system 400 (FIG. 4), or computing system 500 (FIG. 5).

In various examples, method 500 may be performed by hardware, software, firmware, or any combination thereof. Other suitable systems and/or computing devices may be used as well. Method 500 may be implemented in the form of executable instructions stored on at least one machine-readable storage medium of the system and executed by at least one processor of the system. Alternatively or in addition, method 500 may be implemented in the form of electronic circuitry (e.g., hardware). In alternate examples of the present disclosure, one or more blocks of method 500 may be executed substantially concurrently or in a different order than shown in FIG. 5. In alternate examples of the present disclosure, method 500 may include more or fewer blocks than are shown in FIG. 5. In some examples, one or more of the blocks of method 500 may, at certain times, be ongoing and/or may repeat.

Method 500 may start at block 502 at which point memory controller 118 and/or memory 106 may issue a write request (e.g. write request 102A). The write request is associated with a subarray of a memory. At block 504, memory 106 may execute the write request.

At block 506, memory controller 118 and/or memory 106 may determine that write request 102A has not completed within an allocated number of write cycles. At block 508, responsive to determining that the write request has not completed, memory 106 may store the write request in an extension buffer, e.g. write extension buffer 114.

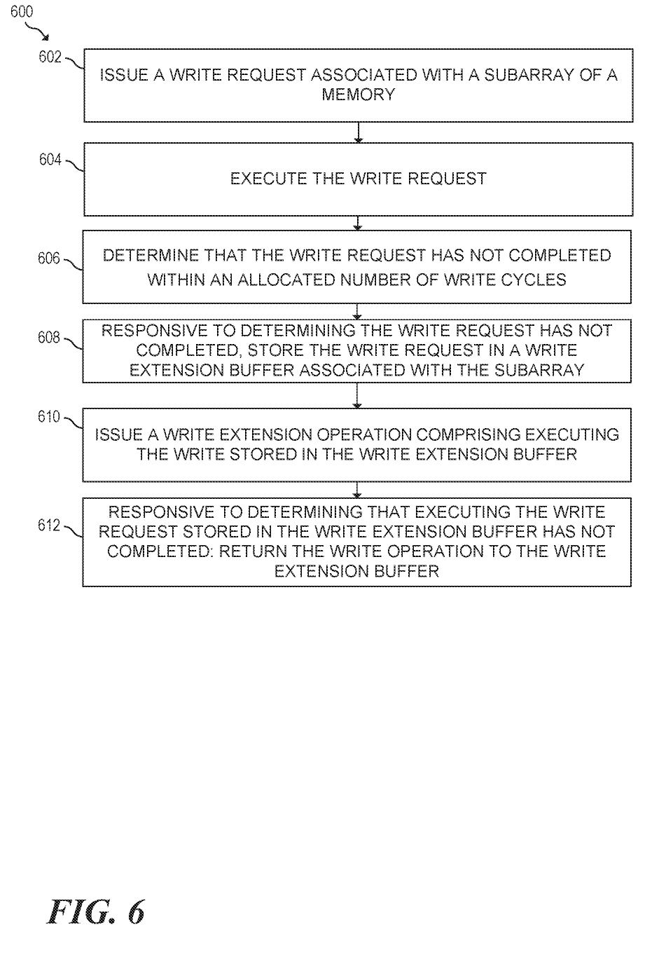

FIG. 6 is a flowchart of an example method for performing staging of write requests. FIG. 6 illustrates method 600. Method 600 may be described below as being executed or performed by a system, for example, computing system 100 (FIG. 1), computing system 200 (FIG. 2), computing system 300 (FIG. 3), or computing system 400 (FIG. 4). Other suitable systems and/or computing devices may be used as well. Method 600 may be implemented in the form of executable instructions stored on at least one machine-readable storage medium of the system and executed by at least one processor of the system. Method 600 may be performed by hardware, software, firmware, or any combination thereof.

Alternatively or in addition, method 600 may be implemented in the form of electronic circuitry (e.g., hardware). In alternate examples of the present disclosure, one or more blocks of method 600 may be executed substantially concurrently or in a different order than shown in FIG. 6. In alternate examples of the present disclosure, method 600 may include more or fewer blocks than are shown in FIG. 6. In some examples, one or more of the blocks of method 600 may, at certain times, be ongoing and/or may repeat.

In various examples, method 600 may start at block 602 at which point memory controller 118 may issue a write request (e.g. write request 102A). The write request is associated with a subarray (e.g. subarray 108). At block 604, memory 106 may execute the write request.

At block 606, memory controller 118 may cause and/or memory 106 may determine that the write request has not completed within an allocated number of write cycles. At block 608, responsive to determining the write request has not completed, memory 106 may store the write request in a write extension buffer associated with the subarray (e.g. write extension buffer 114).

At block 610, memory controller 118 may issue a write extension operation (e.g. write extension operation 202, 402). Memory 106 may receive the issued write extension operation. The write extension operation may cause memory 106 to execute the write request (e.g. write request 102D). In various examples, memory controller 118 may cause memory 106 to execute the write extension operation stored in the write extension buffer using modified write parameters. In various examples, memory controller 118 may issue the write extension operation based on at least one of: a number of write cycles that have elapsed since executing a previous write extension operation, a number of write cycles that have elapsed, or a number of writes that have elapsed. In some examples, memory controller 118 may issue the write extension operation based on an observed error rate of the memory.

At block 612, memory controller 118 and/or memory 106 may determine that executing the write request stored in the write extension buffer has not completed. Responsive to making that determination, memory 106 may maintain or return the write operation (e.g. write operation 102E) to the write extension buffer (e.g. write extension buffer 114).

1. A method comprising:
issuing a write request, wherein the write request is associated with a subarray of a memory;
executing the write request;
determining that the write request has not completed within an allocated number of write cycles; and
responsive to determining that the write request has not completed, storing, by the memory, the write request in a write extension buffer, wherein the write extension buffer is associated with the subarray.

2. The method of claim 1, comprising:
issuing a write extension operation, wherein the write extension operation comprises:
executing, the write request stored in the write extension buffer.

3. The method of claim 2, wherein executing the write extension operation stored in the write extension buffer comprises executing the write extension operation using modified write parameters.

4. The method of claim 2, comprising issuing the write extension operation based on at least one of: a number of write cycles that have elapsed since executing a previous write extension operation, a number of write cycles that have elapsed, or a number of writes that have elapsed.

5. The method of claim 2, comprising issuing the write extension operation based on performing the write extension operation based on an observed error rate of the memory.

6. The method of claim 1, comprising:
executing the write request stored in the write extension buffer; and
responsive to determining that executing the write request stored in the write extension buffer has not completed:
returning the write operation to the write extension buffer.

7. A device comprising a memory comprising:
a subarray having an associated write extension buffer; and
request logic to:
receive a write request associated with the subarray:
execute the write request;
determine that the write request has not completed within an allocated number of write cycles; and
responsive to determining that the write request has not completed the allocated number of write cycles:
store the write request in the write extension buffer.

8. The device of claim 7, the request logic to:
execute a write extension operation, wherein to execute write extension operation, the request logic to:
execute the write request stored in the write extension buffer.

9. The device of claim 8, wherein the request logic to execute the write operation stored in the write extension buffer using modified write parameters.

10. The device of claim 8, wherein the request logic to perform the write extension operation based on a number of write cycles that have elapsed since executing a previous write extension operation.

11. The device of claim 8, wherein the request logic to perform the write extension operation based on an observed error rate of the memory.

12. The device of claim 7, wherein the request logic to:
execute the write request stored in the write extension buffer; and
responsive to determining that executing the write request stored in the write extension buffer has not completed:
return the write operation to the write extension buffer.

13. A device comprising a memory controller comprising:
a request controller; to:
issue, to a memory coupled to the controller, a write request associated with a subarray of the memory;
determine that the write request has not completed within an allocated number of write cycles to execute; and
responsive to determining that the write request has not completed within the allocated number of write cycles to execute:
cause the memory to store the write request in a write extension buffer of the memory.

14. The device of claim 13, the request controller to:
issue a write extension operation to cause the memory to execute the write request stored in the write extension buffer.

15. The device of claim 13, wherein the request controller to cause the memory to execute the write operation stored the write extension buffer using modified write parameters.

16. The device of claim 13, wherein issuing the write extension operation is based on at least one of: a number of write cycles that have elapsed since executing a previous write extension operation, a number of write cycles that have elapsed, or a number of writes that have elapsed.

17. The device of claim 13, wherein the request controller to issue the write extension operation based on an observed error rate of the memory.

18. The device of claim 13, wherein the request controller to:
issue the write extension operation to cause the memory to execute the write request stored in the write extension buffer; and
responsive to determining that the write request stored in the write extension buffer has not completed:
cause the memory to return the write operation to the write extension buffer.
